(19) United States
(12) Patent Application Publication
(10) Pub. No.: US 2008/0133729 A1
(43) Pub. Date: Jun. 5, 2008

(54) SYSTEM AND METHOD FOR MANAGING DOMAIN POLICY FOR INTERCONNECTED COMMUNICATION NETWORKS

(75) Inventors: Sharon FRIDMAN, London (GB); Ben Volach, Sterling, VA (US); Ran Makavy, Sterling, VA (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: NeuStar, Inc., Sterling, VA (US)

(21) Appl. No.: 11/840,846

(22) Filed: Aug. 17, 2007

Related U.S. Application Data
(60) Provisional application No. 60/838,157, filed on Aug. 17, 2006.

(51) Int. Cl. G06F 15/173

(52) U.S. Cl. 709/223

(57) ABSTRACT

The present invention is directed to a system and method for managing domain policy for interconnected communication networks. The present invention governs communication service policy for interconnection among remote communication services to allow users to communicate with other users in remote domains. Exemplary embodiments allow the local communication services to guarantee certain service aspects even when remote domains are involved. For example, the local service enablers can assert their local service policy across domains. A local service enabler can choose other service enablers in remote domains based on specific criteria that meets the local service enabler's settings and user preferences. The local service enabler can protect itself from connection to other service enablers that may contradict its local settings. Thus, the present invention can manage communication services across remote domains, while each domain can continue to be managed locally according to the needs and preferences of the local users.

The present application claims priority under 35 U.S.C. § 119(e) to U.S. Provisional Application No. 60/838,157, filed on Aug. 17, 2006, the entire contents of which are hereby incorporated by reference herein.

### BACKGROUND

1. Field of the Invention

The present invention relates to communication systems. More particularly, the present invention relates to a system and method for managing domain policy for interconnected communication networks.

2. Background Information

Communication services and systems, such as presence and instant messaging (IM) systems, can allow a user to communicate with local domain contacts using various types of communication protocols and media. For example, Session Initiation Protocol (SIP) and SIP for Instant Messaging and Presence Leveraging Extensions (SIMPLE) based IM and presence systems are increasingly being adopted as rapid and efficient mechanisms for communication between parties. Such systems are described in, for example: Internet Engineering Task Force (IETF), Network Working Group, Request for Comments (RFC) 3428, “Session Initiation Protocol (SIP) Extension for Instant Messaging” (December 2002); IETF, Network Working Group, RFC 3856, “A Presence Event Package for the Session Initiation Protocol (SIP)” (August 2004); IETF, Network Working Group, RFC 3863, “Presence Information Data Format (PIDF)” (August 2004); IETF, Network Working Group, RFC 2778, “A Model for Presence and Instant Messaging” (February 2000); IETF, Network Working Group, RFC 2779, “Instant Messaging/Presence Protocol Requirements” (February 2000); and IETF, Network Working Group, RFC 3261, “SIP: Session Initiation Protocol” (June 2002).

The previously-described communication services and systems can be interconnected to allow users to communicate with users in remote domains. The interconnection of two or more communities of messaging users for presence and IM systems is described in, for example, E. Aoki, A. Houri, O. Levin, T. Rang, and M. Trommsdorff, IETF, SIMPLE Working Group, Internet-Draft, “Best Current Practices for Inter-domain Instant Messaging using SIP/SIMPLE” (Jul. 21, 2006). A messaging community administers its own namespace of SIP addresses or has other appropriate administrative authority over a collection of users. The users of an enterprise, the subscribers of a mobile operator, or the customers of a given service provider are examples of such communities.

FIG. 1 is a diagram illustrating a deployment topology for interconnecting two SIP/SIMPLE communities. Domain A and Domain B are interconnected through a public network 105. Within each domain are illustrated the logical SIP/SIMPLE entities internal to each community that participate in different aspects of presence and IM. For example, each domain can include user agents 110 (e.g., user agent A from Domain A, and user agent B from Domain B), user registrars 115 (e.g., user registrar A from Domain A, and user registrar B from Domain B), and suitable service enablers, such as presence servers 120 (e.g., presence server A from Domain A, and presence server B from Domain B).

The edge proxies 125 for a given community (e.g., edge proxy A from Domain A, and edge proxy B from Domain B) are SIP proxies that have the ability and authority to route traffic from the network 105 to the SIP entities within that community. Each edge proxy 125 services their respective community. In other words, each edge proxy 125 “listens” for requests intended for a given community (identified by its domain), routes the SIP traffic to and from the community, and, in some cases, provides authoritative answers on behalf of the users and entities within that community.

However, the management and administration of the user agents 110, user registrars 115, and presence servers 120, the namespaces they occupy, and the local policies that apply to those entities remain under the administrative control of the local community. Therefore, there is a need for policy administration across the interconnected networks to facilitate communication between entities in different domains, and to govern the interconnection link between the aforementioned domains.

### SUMMARY OF THE INVENTION

A system and method are disclosed for managing domain policy for interconnected communication networks. In accordance with exemplary embodiments of the present invention, according to a first aspect of the present invention, an apparatus for managing domain policy across communication systems includes a network interconnection node. The network interconnection node is in communication with a plurality of edge proxy nodes. Each edge proxy node is configured to service a messaging community of users. Each messaging community is governed by a local communication domain policy. The network interconnection node includes a communication domain policy mediation module. The communication domain policy mediation module is configured to negotiate communication domain policy attributes between different messaging communities for communicating messages between the different messaging communities.

According to the first aspect, the network interconnection node can include an interconnection administration module. The interconnection administration module can be configured to manage communication domain policy attribute information associated with the communication domain policy of each messaging community. The interconnection administration module can be configured to access the communication domain policy of each messaging community. The interconnection administration module can be configured to govern inter-domain communication policy for communicating the messages between the different messaging communities. The network interconnection node can include an attribute information storage module. The attribute information storage module can be configured to store communication domain policy attribute information associated with the communication domain policy of each messaging community. The network interconnection node can include an information communication module. The information communication module can be configured to communicate communication domain policy attribute information with each messaging community via the respective edge proxy nodes. The network interconnection node can include a communication domain policy enforcement module. The communication domain policy enforcement module can be configured to enforce communication domain policy between different messaging communities.

According to the first aspect, the network interconnection node can be in communication with a second network interconnection node. The second network interconnection node can be in communication with a second plurality of edge proxy nodes. The first and second network interconnections nodes can be configured to negotiate the communication domain policy attributes for communicating a message between a first messaging community associated with a first edge proxy node of the plurality of edge proxy nodes and a second messaging community associated with a second edge proxy node of the second plurality of edge proxy nodes. According to an exemplary embodiment of the first aspect, at least one edge proxy node can comprise a messaging service enabler or the like. Each user can comprise, for example, a communication device. Accordingly, the communication domain policy of each messaging community can comprise predetermined communication device requirements. The communication domain policy of each messaging community can comprise a cost for messaging service usage. The communication domain policy of each messaging community can comprise communication addressing information. Each messaging community can comprise an instant messaging (IM) and presence network or the like. The communicated messages can comprise, for example, presence information and instant messages or the like.

According to a second aspect of the present invention, a system for managing domain policy for interconnected communication networks includes a first interconnection node. The first interconnection node is in communication with a first plurality of edge proxy nodes. The system includes a second interconnection node in communication with the first interconnection node. The second interconnection node is in communication with a second plurality of edge proxy nodes. Each edge proxy node is configured to service a messaging community of users. Each messaging community is governed by a messaging policy. Each of the first and second interconnection nodes includes an inter-domain messaging policy mediation module. The inter-domain messaging policy mediation module is configured to negotiate messaging policy attributes for communicating a message between a first messaging community of the first plurality of edge proxy nodes and a second messaging community of the second plurality of edge proxy nodes.

According to the second aspect, the system can include an interconnection management module in communication with the first and second interconnection nodes. The interconnection management module can be configured to manage inter-domain communication policy for communicating messages between different messaging communities. Each of the first and second interconnection nodes can comprise a messaging policy information storage module. The messaging policy information storage module can be configured to store messaging policy attribute information associated with the messaging policy of each messaging community. Each of the first and second interconnection nodes can include a messaging policy information communication module. The messaging policy information communication module can be configured to communicate messaging policy attribute information with each messaging community via the respective edge proxy nodes. Each of the first and second interconnection nodes can include a messaging policy enforcement module. The messaging policy enforcement module can be configured to enforce messaging policy between different messaging communities.

According to a third aspect of the present invention, a system for managing domain policy for interconnected communication networks includes a plurality of messaging service enablers in communication with one another. Each messaging service enabler is configured to service a messaging community of users. Each messaging community is governed by a messaging domain policy. Each messaging service enabler comprises network interconnection structure. The network interconnection structure includes inter-domain messaging policy negotiation structure. The inter-domain messaging policy negotiation structure is configured to mediate messaging domain policy attributes between remote messaging communities for communicating messages between the remote messaging communities.

According to the third aspect, the network interconnection structure of each messaging service enabler can comprise a messaging policy information database. The messaging policy information database can be configured to store messaging policy attribute information associated with the messaging policy of each messaging community. The network interconnection structure of each messaging service enabler can include messaging communication structure. The messaging communication structure can be configured to communicate messaging policy attribute information with each messaging community via the respective messaging service enablers. The network interconnection structure of each messaging service enabler can include messaging policy enforcement structure. The messaging policy enforcement structure can be configured to enforce messaging policy between remote messaging communities.

According to a fourth aspect of the present invention, a method of managing domain policy across communication systems includes the step of governing communications among a plurality of remote edge proxy nodes. Each edge proxy node is configured to service a messaging community of users. Each messaging community is governed by a local communication domain policy. The governing step includes the step of negotiating communication domain policy attributes between different messaging communities for communicating messages between the different messaging communities.

According to the fourth aspect, the governing step can include one or more of the following steps: managing communication domain policy attribute information associated with the communication domain policy of each messaging community; accessing the communication domain policy of each messaging community; governing inter-domain communication policy for communicating the messages between the different messaging communities; storing communication domain policy attribute information associated with the communication domain policy of each messaging community; communicating communication domain policy attribute information with each messaging community via the respective edge proxy nodes; and enforcing communication domain policy between different messaging communities.

According to the fourth aspect, the method can include the step of governing communications among a second plurality of remote edge proxy nodes. The method can include the step of negotiating the communication domain policy attributes between the governing steps to communicate a message between a first messaging community associated with a first edge proxy node of the plurality of edge proxy nodes and a second messaging community associated with a second edge proxy node of the second plurality of edge proxy nodes. According to an exemplary embodiment of the fourth aspect, at least one edge proxy node can comprise a messaging service enabler. Each user can comprise, for example, a communication device or the like. The communication domain policy of each messaging community can comprise predetermined communication device requirements. The communication domain policy of each messaging community can comprise a cost for messaging service usage. The communication domain policy of each messaging community can comprise communication addressing information. Each messaging community can comprise, for example, an IM and presence network or the like. The communicated messages can comprise, for example, presence information and instant messages or the like.

According to a fifth aspect of the present invention, a method of managing domain policy for interconnected communication networks includes the steps of: governing communications among a first plurality of edge proxy nodes; governing communications among a second plurality of edge proxy nodes, wherein each edge proxy node is configured to service a messaging community of users, and wherein each messaging community is governed by a messaging policy; and negotiating messaging policy attributes between the governing steps to communicate a message between a first messaging community of the first plurality of edge proxy nodes and a second messaging community of the second plurality of edge proxy nodes.

According to the fifth aspect, the method can include the step of managing inter-domain communication policy for communicating messages between different messaging communities. Each of the governing steps can include one or more of the following steps: storing messaging policy attribute information associated with the messaging policy of each messaging community; communicating messaging policy attribute information with each messaging community via the respective edge proxy nodes; and enforcing communication domain policy between different messaging communities.

According to a sixth aspect of the present invention, an apparatus for managing domain policy across communication systems includes means for interconnecting networks. The network interconnecting means is in communication with a plurality of edge proxy nodes. Each edge proxy node is configured to service a messaging community of users. Each messaging community is governed by a local communication domain policy. The network interconnecting means includes means for mediating communication domain policy. The communication domain policy mediating means is configured to negotiate communication domain policy attributes between different messaging communities for communicating messages between the different messaging communities.

According to the sixth aspect, the network interconnecting means can include means for administering interconnectivity. The interconnectivity administering means can be configured to manage communication domain policy attribute information associated with the communication domain policy of each messaging community. The interconnectivity administering means can be configured to access the communication domain policy of each messaging community. The interconnectivity administering means can be configured to govern inter-domain communication policy for communicating the messages between the different messaging communities. The network interconnecting means can include means for storing attribute information. The attribute information storing means can be configured to store communication domain policy attribute information associated with the communication domain policy of each messaging community. The network interconnecting means can include means for communicating attribute information. The information communicating means can be configured to communicate communication domain policy attribute information with each messaging community via the respective edge proxy nodes. The network interconnecting means can include means for enforcing communication domain policy. The communication domain policy enforcing means can be configured to enforce communication domain policy between different messaging communities.

According to the sixth aspect, the network interconnecting means can be in communication with a second network interconnecting means. The second network interconnecting means can be in communication with a second plurality of edge proxy nodes. The first and second network interconnecting means can be configured to negotiate the communication domain policy attributes for communicating a message between a first messaging community associated with a first edge proxy node of the plurality of edge proxy nodes and a second messaging community associated with a second edge proxy node of the second plurality of edge proxy nodes. According to an exemplary embodiment of the sixth aspect, at least one edge proxy node can comprise means for enabling messaging service. Each user can comprise, for example, a means for communicating. The communication domain policy of each messaging community can comprise predetermined communicating means requirements. The communication domain policy of each messaging community can comprise a cost for messaging service usage. The communication domain policy of each messaging community can comprise communication addressing information. Each messaging community can comprise, for example, an IM and presence network or the like. Accordingly, the communicated messages can comprise presence information and instant messages or the like.

According to an seventh aspect of the present invention, a system for managing domain policy for interconnected communication networks includes a first means for interconnecting networks. The first network interconnecting means is in communication with a first plurality of edge proxy nodes. The system includes a second means for interconnecting networks in communication with the first network interconnecting means. The second network interconnecting means is in communication with a second plurality of edge proxy nodes. Each edge proxy node is configured to service a messaging community of users. Each messaging community is governed by a messaging policy. Each of the first and second network interconnecting means includes means for mediating inter-domain messaging policy. The inter-domain messaging policy mediating means is configured to negotiate messaging policy attributes for communicating a message between a first messaging community of the first plurality of edge proxy nodes and a second messaging community of the second plurality of edge proxy nodes.

According to the seventh aspect, the system can include means for managing network interconnections in communication with the first and second network interconnecting means. The network interconnection managing means can be configured to manage inter-domain communication policy for communicating messages between different messaging communities. Each of the first and second network interconnecting means can include means for storing messaging attribute information. The messaging attribute information storing means can be configured to store messaging policy attribute information associated with the messaging policy of each messaging community. Each of the first and second network interconnecting means can include means for communicating messaging attribute information. The messaging information communicating means can be configured to communicate messaging policy attribute information with each messaging community via the respective edge proxy nodes. Each of the first and second interconnecting means can include means for enforcing messaging policy. The messaging policy enforcing means can be configured to enforce messaging policy between different messaging communities.

According to a eighth aspect of the present invention, a system for managing domain policy for interconnected communication networks includes a plurality of means for enabling messaging service capable of communicating with one another. Each messaging service enabling means is configured to service a messaging community of users. Each messaging community is governed by a messaging domain policy. Each messaging service enabling means includes means for interconnecting networks. The network interconnecting means includes means for negotiating inter-domain messaging policy. The inter-domain messaging policy negotiating means is configured to mediate messaging domain policy attributes between remote messaging communities for communicating messages between the remote messaging communities.

According to the eighth aspect, the network interconnecting means of each messaging service enabling means can include means for storing messaging attribute information. The messaging attribute information storing means can be configured to store messaging policy attribute information associated with the messaging policy of each messaging community. The network interconnecting means of each messaging service enabling means can include means for communicating messaging attribute information. The messaging information communicating means can be configured to communicate messaging policy attribute information with each messaging community via the respective messaging service enabling means. The network interconnecting means of each messaging service enabling means can include means for enforcing messaging policy. The messaging policy enforcing means can be configured to enforce messaging policy between remote messaging communities.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a diagram illustrating a deployment topology for interconnecting two SIP/SIMPLE communities.

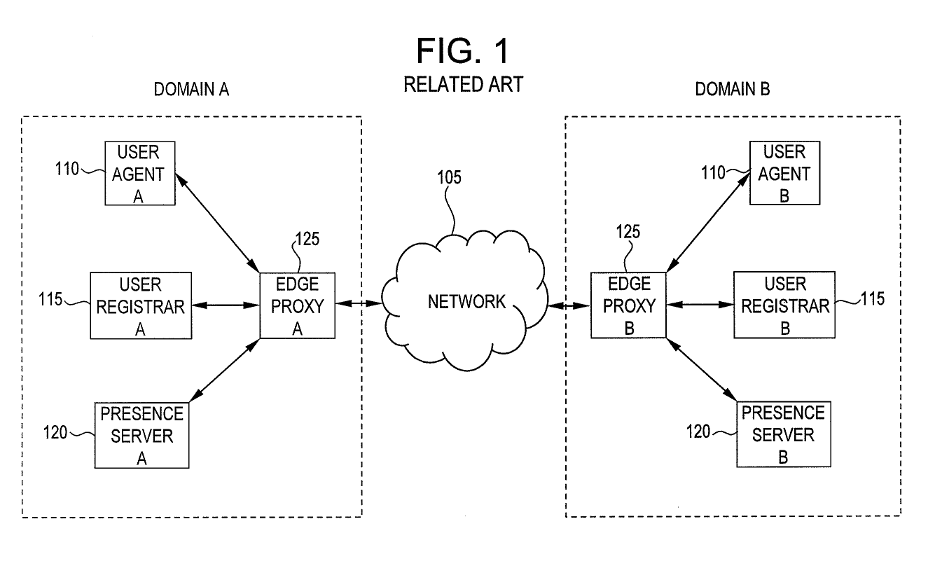

FIG. 2 is a block diagram illustrating a system for managing domain policy across communication systems, in accordance with an exemplary embodiment of the present invention.

FIG. 3 is a block diagram illustrating a system for managing domain policy for interconnected communication networks, in accordance with an alternative exemplary embodiment of the present invention.

FIG. 4 is a block diagram illustrating a system for managing domain policy for interconnected communication networks, in accordance with a further alternative exemplary embodiment of the present invention.

FIG. 5 is a flowchart illustrating steps for managing domain policy across communication systems, in accordance with an exemplary embodiment of the present invention.

FIG. 6 is a flowchart illustrating steps for managing domain policy for interconnected communication networks, in accordance with an exemplary embodiment of the present invention.

FIG. 7 is an alternative illustration of the system shown in FIG. 2 for managing domain policy across communication systems, in accordance with an exemplary embodiment of the present invention.

### DETAILED DESCRIPTION OF THE PREFERRED EMBODIMENTS

Exemplary embodiments of the present invention are directed to a system and method for managing domain policy for interconnected communication networks. The present invention can govern communication service policy for interconnection among remote communication services to allow users to communicate with other users in remote domains. Such inter-domain policy can include, for example, security, privacy, connectivity, authorization, spam prevention, pricing, capabilities, service level agreements, alerting, management, and other like policies. Exemplary embodiments can allow the local communication services to guarantee certain service aspects even when remote domains are involved. For example, the local service enablers can assert their local service policy across domains. A local service enabler can choose other service enablers in remote domains based on specific criteria that meets the local service enabler's settings and user preferences. The local service enabler can also protect itself from connection to other service enablers that may contradict its local settings. Thus, exemplary embodiments provide the ability to manage communication services across remote domains, either centrally or in a distributed manner, while each domain can continue to be managed locally according to the needs and preferences of the local users.

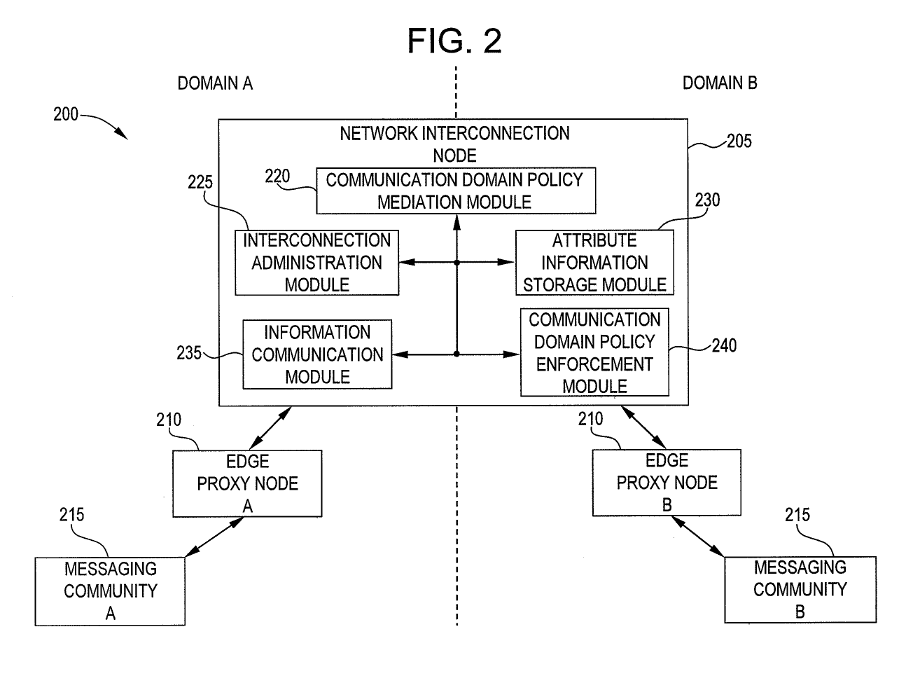

These and other aspects and embodiments of the present invention will now be described in greater detail. FIG. 2 is a block diagram illustrating a system 200 for managing domain policy across communication systems, in accordance with an exemplary embodiment of the present invention. For purposes of illustration and not limitation, two domains, Domain A and Domain B, are illustrated in FIG. 2. Each domain can comprise any suitable type of communication demarcation for differentiating users in one local domain (e.g., Domain A) from users in another local domain (e.g., Domain B). For example, each domain can comprise any appropriate type of local network operator (e.g., fixed, wireless, and/or converged), mobile network operator, mobile virtual network operator, service provider (e.g., an internet service provider, wireless service provider, or the like), wireless carrier, mobile or fixed phone operator, cellular company or organization, a region or other geographic area, or the like, including any suitable combination thereof. The system 200 can support any suitable number (e.g., a first domain, a second domain, a third domain, . . . , a Nth domain, where N is any appropriate number) and types (e.g., wired, wireless, or combination thereof) of domains in accordance with exemplary embodiments of the present invention.

The system 200 includes a network interconnection node 205. The network interconnection node 205 is in communication with a plurality edge proxy nodes 210, such as, for example, edge proxy node A in Domain A, and edge proxy node B in Domain B. The network interconnection node 205 can support communication with any suitable number and types of edge proxy nodes 210 across domains, including multiple edge proxy nodes 210 within a given domain. For example, any suitable type of entry point into a domain can be used as an edge proxy node 210, including, but not limited to, a gateway, a load balancer, a network router or switch, a topology hiding gateway (THIG), or the like. According to exemplary embodiments, each edge proxy node 210 is configured to service a messaging community 215 of users. For example, edge proxy node A is configured to service users in messaging community A in Domain A, while edge proxy node B is configured to service users in messaging community B in Domain B. The system 200 can support any suitable number and types of messaging communities 215. Each messaging community 215 can, for example, administer its own namespace of addresses (e.g., SIP addresses, Wireless Village ID, Instant Messaging (IM) URI, presence URI, Extensible Messaging and Presence Protocol (XMPP) identifier, or any other suitable form of addressing) or has other appropriate administrative authority over a collection of users. The users of an enterprise, the subscribers of a mobile operator, or the customers of a given service provider are examples of such messaging communities 215, although each messaging community 215 can comprise any suitable number and types of users and other like entities.

Each user or user agent in each messaging community 215 can comprise or otherwise be associated with a suitable communication device. The system 200 can support any appropriate number of users and associated communication devices in each messaging community 215 in accordance with exemplary embodiments of the present invention. Each user communication device can comprise any suitable type of wireless or wired communication module or device that is capable of receiving and transmitting messages and other information using any appropriate type of communication service. For example, each of the user communication devices can comprise a mobile device, a personal computer (PC), or the like.

The edge proxy nodes 210 for each messaging community 215 can comprise suitable proxies that are configured with the ability and authority to route traffic from remote domains to the entities within that community. Each edge proxy node 210 can service their respective messaging community 215. In other words, each edge proxy node 210 can be adapted to “listen” for requests intended for a given messaging community 215 (e.g., identified by its domain), route the communication traffic to and from the messaging community 215, and, in some cases, provides authoritative answers on behalf of the users and entities within that messaging community 215. It is noted that SIP and SIP for Instant Messaging and Presence Leveraging Extensions (SIMPLE) based communication services and systems are being discussed merely for purposes of illustration and not limitation. Those of ordinary skill in the art will recognize that other suitable types of communication services and systems can be used according to and supported by exemplary embodiments of the present invention, including, but not limited to, Instant Messaging and Presence Service (IMPS), Open Systems Architecture (OSA)/Parlay, internet service provider, corporate communication system, or other like communication services and systems. For example, each of the edge proxy nodes 210 can comprise any appropriate type of messaging service enabler (e.g., an Instant Messaging (IM) Service Center, such as an IM enabler, or a presence server), or other like messaging or communication server, component or device. Additionally, although each messaging community 215 can comprise a SIP/SIMPLE community or the like, each messaging community 215 can comprise any suitable type of IM and presence network or other appropriate type of network, either wired, wireless, or any combination thereof, as discussed above.

Each messaging community 215 is governed by a local communication domain policy. The local communication domain policy is used for specifying and managing communications among users and other entities within a local domain. For example, such local policies can provide for addressing schemes supported within the local domain, minimum user/device requirements, costs for service usage, and other like rules and preferences. Each messaging community 215 can be governed by a different (local) communication domain policy, depending on the needs and requirements of the users and entities within each community.

The network interconnection node 205 includes a communication domain policy mediation module 220. The communication domain policy mediation module 220 is configured to negotiate communication domain policy attributes between different messaging communities 215 for communicating messages between those different messaging communities 215. According to exemplary embodiments, the communication domain policy attributes can comprise the various communication characteristics or specifications needed to support communication among users within each local domain. However, the communication attributes or characteristics to support communication in one domain may be different than the communication attributes or characteristics needed to support communication in another domain. To support inter-domain communication (e.g., sending a message from a user in messaging community A in Domain A to a user in messaging community B in Domain B), the communication domain policy mediation module 220 can utilize a suitable inter-domain communication policy to mediate or otherwise negotiate communications between two different domains. Such an inter-domain communication policy can be maintained by the network interconnection node 205 (e.g., in a suitable computer memory or other computer storage medium).

The network interconnection node 205 includes a communication domain policy enforcement module 240. The communication domain policy enforcement module 240 is configured to enforce communication domain policy between different messaging communities 215. For example, the communication domain policy enforcement module 240 can be configured to withhold, block, delete, queue, or otherwise manage communications between the domains and messaging communities 215 according to the inter-domain communication policy. In other words, the communication domain policy enforcement module 240 can be adapted to enforce or otherwise executes the rules, preference, policies, or the like specified by the inter-domain communication policy for any and all domains and messaging communities 215. For example, if a sender domain violates inter-domain communication policy, the communication domain policy enforcement module 240 can block, hold, or queue the communication from the sender domain, and provide the sender domain with an indication or other notification (e.g., an appropriate error or other message) that the communication domain policy enforcement module 240 has blocked, held, or queued the communication due to the violation. Such an indication or notification can also include, for example, the nature or description of the violation, such as the inter-domain communication policy that is being enforced. Thus, the communication domain policy mediation module 220 can provide the mediation and oversight of inter-domain communication, while the communication domain policy enforcement module 240 can provide suitable enforcement functionality for the communication domain policy mediation module 220, for example, to allow that module to regulate such inter-domain communication.

The inter-domain communication policy can specify the policies, rules, preferences, or the like for governing interconnectivity between domains. For example, the inter-domain communication policy can specify suitable rules and preferences regarding communication device capabilities (e.g., minimum or other predetermined end-user/device requirements), cost (e.g., cost for service usage), addressing (e.g., supported and required addressing schemes, addressing conversions, support for number portability and mobile number portability, and the like), heartbeat management, version management, and other like communication characteristics for supporting interconnectivity. However, the inter-domain communication policy can specify any suitable inter-domain policies for governing, for example, security, privacy, alerting, management, connectivity, authorization, spam prevention, pricing, capabilities, service level agreements, and other like attributes and characteristics of inter-domain communication. The nature and types of such policies will depend on many factors, including, but not limited to, domain operator policies and preferences, messaging community policies and preferences, user policies and preferences, and other like factors. For example, the inter-domain communication policy can be comprised of a centralized policy that captures the inter-domain policies across all domains. Alternatively, the domain policy associated with each local domain can specify the policies that are needed or required for each remote domain to communicate with the given local domain. For purposes of illustration, the domain policy of Domain A can specify the policies, rules, preferences, or the like for Domain B to communicate with Domain A. Likewise, the domain policy of Domain B can specify the policies, rules, preferences, or the like for Domain A to communicate with Domain A. Any and all such centralized and/or distributed inter-domain communication policies can be managed, accessed, or otherwise used by the communication domain policy mediation module 220 to negotiate communication domain policy attributes between different messaging communities 215 to facilitate inter-domain communication.

For purposes of illustration and not limitation, each domain can maintain multiple gateways for communication. For example, Domain A can use gateway A₁ for intra-domain communication and gateway A₂ for inter-domain communication, while Domain B can use gateway B, for inter-domain communication and gateway B₂ for intra-domain communication. A user in messaging community A desires to send a message to a user in messaging community B. The information on the appropriate gateway in Domain B to which to send the message can be maintained in the inter-domain communication policy. To send the message from Domain A to Domain B, edge proxy node A can send an appropriate query to the network interconnection node 205 (e.g., including an indication of the destination Domain B) to request mediation or negotiation of the communication domain policy attributes between the two domains. The communication domain policy mediation module 220 can respond by sending an indication (e.g., an address) of the gateway to which to send the (inter-domain) message for users in messaging community B (i.e., gateway B₁). For example, the communication domain policy mediation module 220 can access a centralized inter-domain communication policy maintained by the network interconnection node 205, or query or otherwise retrieve the (local) inter-domain communication policy of Domain B from edge proxy node B. Alternatively, the edge proxy node A can access the inter-domain communication policy via the communication domain policy mediation module 220 to retrieve such gateway information (and other communication characteristics of Domain B). With such information, the edge proxy node A can determine that gateway B₁ must be used to send messages to users in messaging community B. Thus, according to exemplary embodiments, each domain can negotiate connectivity to a remote domain in accordance with the inter-domain communication policy using the communication domain policy mediation module 220 of the network interconnection node 205.

Other suitable policies can be specified by the inter-domain communication policy to govern interconnectivity between domains. For example, spam prevention policy can prevent communication from any user matching or otherwise listed on a spam list (e.g., a block list or other such policy or rules that can cover a set of users or domains). Additionally, connection pool policy can specify the minimum size (i.e., bandwidth) of communication connections between domains to guarantee sufficient quality of service and peak communication handling. Security policy can prevent any communication count greater than a specified or predetermined threshold from a specific user in a remote domain, as many communications within a given interval from a particular user could indicate a possible communication attack or other possible security threat. Authorization policy can require a specific authorization rules in a remote domain that is considered sufficiently “safe” to “trust.” Such an authorization policy can require validation of users, for example, using a user name and password, where the password can be unencoded or encoded (e.g., BASE64 encryption, MD5 or other hashing encryption, 2048-bit password encryption, or the like, depending on the level of authentication and security that is desired). Communication attachment policy can specify whether media or other content included with or otherwise attached to a communication should be passed along with the communication (thereby increasing the size of the communication) or as an accessible link to the content (e.g., requiring an upload/download that is accessible to the sending and receiving domains). Alert policy can specify administrative actions that are to be undertaken according to, for example, the hourly count of communications sent by a domain. For example, for a communication count from zero to a first quantity N₁, no action is to be taken. From N₁ to a second quantity N₂, an e-mail alert is to be sent (e.g., from the communication domain policy enforcement module 24) to the domain administrator notifying that the communication count has passed N₁. When the communication count exceeds N₂, an SMS message can be sent (e.g., from the communication domain policy enforcement module 24) to the domain administrator at every X additional communication (e.g., notifying of a peak condition).

Additionally, pricing policy can specify how much a destination domain charges as a termination fee from the originating domain. For example, the destination pricing policy can comprise a graded table or the like that can specify thresholds at which prices for communication increase (e.g., communication is free up to a first threshold of message count and/or media types, from the first threshold to a second threshold the price becomes $X per message, from the second threshold to a third threshold the price increases to $(X+10) per message, and the like). The source pricing policy can specify the threshold that the source domain is willing to pay for communications to a destination domain. Accordingly, every communication from the source domain to the destination domain can be monitored (e.g., by the communication domain policy mediation module and/or the communication domain policy enforcement module 240) to ensure compliance with the pricing policies. For example, a source domain can establish that communications that cost above a first tariff threshold are to be blocked. Consequently, communications that are free or that cost up to a first tariff can be passed from the source to the destination domain. However, once the tariff increases above the first tariff (e.g., subsequent communications are charged at a second tariff), the traffic from the source to the destination domain can be blocked (e.g., by enforcement of the pricing policy by the communication domain policy enforcement module 240). The communication domain policy enforcement module 240 can then pass a message or other indication or notification to the source domain that the communications have been blocked. Any and all such policies can be used and enforced by the communication domain policy mediation module 220 and the communication domain policy enforcement module 240. For example, an inter-domain communication policy can specify that a suitable SNMP trap is to be sent or a call to an appropriate API provided by a domain is to be called upon the occurrence of a particular event.

The inter-domain communication policy can be accessed using any suitable method and the inter-domain communication policy document can comprise any appropriate information format. Examples of access and document format include, but are not limited to, web service (e.g., Simple Object Access Protocol (SOAP)), Extensible Markup Language (XML) document and XCAP (XML Configuration Access Protocol), HTTP and configuration files, SIP (e.g., using an OPTIONS or OPTIONS-like method), SQL query and database, Lightweight Directory Access Protocol (LDAP) and policy profile, and other like access mechanisms and information formats. For example, the SIP method OPTIONS allows a user (or user agent) to query another user (or user agent) or a proxy server as to its capabilities. Such a mechanism allows a client to discover information about the supported methods, content types, extensions, codecs, and the like without “ringing” the other party. According to an exemplary embodiment, before a user inserts a Require header field into an INVITE listing an option that it is not certain the destination user supports, the edge proxy node 210 can query the communication domain policy mediation module 220 with an OPTIONS to determine if this option is returned in a Supported header field, based on information maintained in the inter-domain communication policy by the network interconnection node 205.

According to an alternative embodiment, the edge proxy node A can send the message to the network interconnection node 205 indicating the destination of Domain B. The communication domain policy mediation module 220 can be configured to modify or otherwise convert the message to be compatible with the communication domain policy attributes supported by the messaging community B. For example, the edge proxy node A can send the message to both gateways B₁ and B₂. By referring to the inter-domain communication policy, the communication domain policy mediation module 220 can suitably modify the message so that the message is only sent to gateway B₁. Alternatively, if communication from messaging community A to messaging community B is to be blocked (in accordance with security policies established by and for messaging community A), the communication domain policy mediation module 220 can return a suitable communication failure or error message to the edge proxy node A (with or without the original message) to indicate the communication blockage. In such a scenario, the communication domain policy enforcement module 240 can be used to enforce such communication blocking.

Thus, according to the present alternative exemplary embodiment, the network interconnection node 205 can negotiate connectivity between remote domains on behalf of those domains in accordance with the inter-domain communication policy using the communication domain policy mediation module 220. In other words, the communication domain policy mediation module 220 can serve as a messaging interface to allow messages to be passed between Domain A and Domain B. Thus, the edge proxy nodes 210 would be “unaware” of the differences in communication domain policies between different messaging communities 215, as the communication domain policy mediation module 220 can handle compatibility between messaging communities 215 and perform the message conversion to facilitate such compatibility.

Exemplary embodiments can allow the local messaging communities 215 to guarantee certain communication service aspects even when remote domains are involved. For example, the local edge proxy nodes 210 can assert their local communication domain policy across domains. Continuing with the previous illustration, since inter-domain communications destined for Domain B must arrive on gateway B₁, the edge proxy node B can ensure that edge proxy node A uses gateway B₁ when communicating messages to Domain B. Such enforcement can be ensured via the inter-domain communication policy using the communication domain policy mediation module 220 and enforced using the communication domain policy enforcement module 240.

Additionally, the local edge proxy nodes 210 can choose or select other edge proxy nodes 210 in remote domains based on appropriate criteria that meets the settings of the local edge proxy node 210 and the preferences of the users in the corresponding messaging community 215. For example, the edge proxy node B can choose to communicate only with other edge proxy nodes 210 that service messaging communities 215 for which the destination charges (termination fees) are no more than a first tariff level, such as edge proxy node A. If an edge proxy node 210 services a messaging community 215 or domain that charges more than the first tariff level, the edge proxy node B can block or otherwise prevent users of messaging community B from communicating messages to that other messaging community 215. For example, if the messaging community A or its domain charges a second tariff level that is greater than the first tariff level, the edge proxy node B can prevent users in messaging community B from sending messages to users in messaging community A (e.g., by providing a suitable error or failure message to users in messaging community B if such communication to messaging community A is attempted). Again, such selection of remote domains can be supported using the inter-domain communication policy maintained by the communication domain policy mediation module 220.

According to an exemplary embodiment, a local edge proxy node 210 can also protect itself from connection to remote edge proxy nodes 210 that may contradict the settings of the local edge proxy node 210. For example, if the users of messaging community A are on a spam (i.e., block) list, the edge proxy node B can block edge proxy node A from sending messages to the users of messaging community B to prevent spamming. For example, the edge proxy node B can prevent the edge proxy node A from making a connection by denying connection requests, returning or dropping messages from edge proxy node A, or the like. Regarding security policies, for example, the edge proxy node A can maintain a security policy the prevents unauthorized access to the users of messaging community A. Accordingly, edge proxy node A can block edge proxy node B from sending messages to the users of messaging community A if edge proxy node B does not support a similar security policy that prevents unauthorized access to the users of messaging community B. Again, the edge proxy node A can prevent the edge proxy node B from making a connection by denying connection requests, returning or dropping messages from edge proxy node B, or the like. The inter-domain communication policy maintained by the communication domain policy mediation module 220 can specify which remote domains should be blocked.

According to one exemplary embodiment, the communication domain policy mediation module 220 can include appropriate look-up tables for the inter-domain communication policy for negotiating communication domain policy attributes between remote domains. Such look-up tables can be stored in a suitable computer memory or other computer storage device internal to or in communication with the communication domain policy mediation module 220. For purposes of illustration and not limitation, Table 1 illustrates an exemplary lookup table that can be used for negotiating communication domain policy attributes between different domains. For purposes of illustration and not limitation, three domains are illustrated in Table 1: Domain A, Domain B, and Domain C. Table 1 specifies the inter-domain gateways required by each domain.

TABLE 1
Exemplary inter-domain communication policy look-up table
specifying gateway information supported by remote domains.

| | (1) DOMAIN | | |
|---|---|---|---|
| | A | (2) DOMAIN B | (3) DOMAIN C |
| (1) DOMAIN A | Gateway A₁ | Gateway B₃ | Gateway C₂ |
| (2) DOMAIN B | Gateway A₁ | Gateway B₃ | BLOCK |
| (3) DOMAIN C | Gateway A₁ | BLOCK | Gateway C₂ |

By selecting the appropriate row and column of Table 1, the correct gateway to which communications are to be sent for each messaging community 215 for achieving inter-domain communication between those communities can be determined. In the present illustration, Domain A uses Gateway A₁ for inter-domain communication (see row 1, column 1). Domain B supports uses Gateway B₃ for inter-domain communication (see row 2, column 2). Domain C uses Gateway C₂ for inter-domain communication (see row 3, column 3). If a user in Domain A desires to send a message to a user in Domain B, Table 1 can be accessed at (row 1, column 2) to determine that such messages must be sent to Gateway B₃. For messages from Domain B to Domain A, Table 1 can be accessed at (row 2, column 1) to determine that the messages must be sent to Gateway A₁.

Continuing with the present illustration, if a user in Domain C desires to send a message to a user in Domain A, Table 1 can be accessed at (row 3, column 1) to determine that such messages must be sent to Gateway A₁. For messages from Domain A to Domain C, Table 1 can be accessed at (row 1, column 3) to determine that the messages must be sent to Gateway C₂. However, Table 1 indicates that message exchanges between users in Domain B and users in Domain C are to be blocked or otherwise prevented, as indicated in (row 2, column 3) and (row 3, column 2). For example, Domains B and C could support different pricing policies that are not compatible with the respective domains' local communication policies. In the present illustration, policies for Domains B and C can specify that edge proxy nodes 210 in remote domains are not to be selected if those remote edge proxy nodes 210 do not meet the communication pricing policy settings of the local domain.

Using such a lookup table as that illustrated in Table 1, the communication domain policy mediation module 220 can negotiate or assist in negotiating communication domain policy attributes between different messaging communities 215. Such a lookup table can be configured to maintain any suitable types of communication domain policy attributes. Those of ordinary skill in the art will recognize that the nature and content of the information contained in such a look-up table will depend on, for example, the number and types of domains, edge proxy nodes 210, and respective messaging communities 215, the types of communication services and systems supported by the messaging communities 215 and domains, and other like factors.

Alternatively, suitable Boolean or other logic or rules can be used to negotiate communication domain policy attributes between different messaging communities 215. For example, continuing with the present illustration, Boolean logic can be used to determine that IF a message is to be sent from a user in Domain A to a user in Domain B, THEN the edge proxy node 210 of Domain A must use Gateway B₃ to communicate the message to Domain B. Likewise, Boolean logic can be used to determine that IF a message is to be sent from a user in Domain C to a user in Domain A, THEN the edge proxy node 210 of Domain C must use Gateway A₁ to communicate the message to Domain A. Finally, Boolean logic can be used to determine that IF a message is to be sent from a user in Domain B to a user in Domain C, THEN the message exchange must be blocked. The complexity of such logic or rules will depend on the nature and type of the communication domain policy attributes supported by each domain, the number and types of domains, as well as other like factors. More complex mechanisms, such as neural networks, can be adapted to “learn” how to respond to such requests for interconnectivity. For example, according to an exemplary embodiment, the communication domain policy mediation module 220 can “learn” that the edge proxy nodes 210 of the messaging communities 215 of Domains A and B must use Gateways A₁ and B₃, respectively, to exchange messages between those two domains. Such information can be fed back to the communication domain policy mediation module 220 to allow such “learning” to take place and to refine these or other communication domain policy attribute negotiation or mediation algorithms.

As discussed previously, the domain policy associated with each local domain can specify the policies that are needed or required for each remote domain to communicate with the given local domain. Any local domain policy can also assign particular “hooks,” or entry points, or APIs that are to be called in response to certain triggers or other conditions. According to an exemplary embodiment, such local domains can enforce their local domain policy themselves for inter-domain communication. The communication domain policy enforcement module 240 can be configured to “catch” the trigger and call the appropriate designated hook or API to provide the desired functionality to support such inter-domain communication for those domains. For purposes of illustration and not limitation, a trigger can comprise, for example, a message count greater than a predetermined threshold, a message received from a particular domain (e.g., hacker.com domain), a pricing threshold set to FREE pricing only (e.g., for either the source or destination domain), a data structure representing a web service call, or other like trigger or condition.

The network interconnection node 205 can include an interconnection administration module 225. The interconnection administration module 225 can be in communication with the communication domain policy mediation module 220. The interconnection administration module 225 can be configured to manage communication domain policy attribute or other like information associated with the communication domain policy of each messaging community 215. In other words, the interconnection administration module 225 can be adapted to govern, manage and update the inter-domain communication policy for communicating messages between the different messaging communities 215. For example, the interconnection administration module 225 can be configured to access the communication domain policy of each messaging community 215 to populate and update the inter-domain communication policy. For example, the interconnection administration module 225 can set pricing policy to establish the threshold up to which a source domain is willing to pay for communications to a destination domain. The interconnection administration module 225 can also be used to manage preferences and policies from each, any, or all entities that use or are otherwise associated with the system 200, such as, for example, one or more communication service operators of the domains. Such operators can establish appropriate preferences or policies that are applicable to users and domains for interconnectivity, all of which can be managed and maintained according to exemplary embodiments. For example, an operator in a first domain can establish a preference or policy that the communication domain policy mediation module 220 will negotiate that a certain pricing policy must be adhered to by a second domain when exchanging message between those domains.

The network interconnection node 205 can include an attribute information storage module 230 that can be in communication with either or both of the communication domain policy mediation module 220 and the interconnection administration module 225. The attribute information storage module 230 can be configured to store communication domain policy attribute or other like information associated with the communication domain policy of each messaging community 215. For example, the attribute information storage module 215 can store the inter-domain communication policy or any other suitable policies and preferences applicable to interconnectivity among the domains. The communication domain policy mediation module 220 can access or otherwise retrieve such policy and preference information from the attribute information storage module 230 when negotiating communication domain policy attributes between different messaging communities. Likewise, the communication domain policy enforcement module 240 can access or otherwise retrieve such policy and preference information from the attribute information storage module 230 when enforcing communication domain policy attributes between different messaging communities. However, the attribute information storage module 230 can be used to store any suitable type of information used or maintained by the network interconnection node 205 and the system 200. The attribute information storage module 230 can be comprised of any suitable type of computer-readable or other computer storage medium capable of storing information in electrical or electronic form.

To facilitate communication between the network interconnection node 205 and the edge proxy nodes 210, the network interconnection node 205 can include an information communication module 235. The information communication module 235 can be in communication with each, any, or all of the other modules of the network interconnection node 205. The information communication module 235 can be configured to communicate communication domain policy attribute information or other like information with each edge proxy node 210 or each messaging community 215 via the respective edge proxy nodes 210. However, each of the modules of the network interconnection node 205 can use the information communication module 235 to communicate any suitable type of information to users, edge proxy nodes 210, messaging communities 215, and other entities using or otherwise associated with the system 200. For example, the communication domain policy enforcement module 240 can use the information communication module 235 to inform or otherwise notify domains, messaging communities 215, or the like when inter-domain communication policy has been violated by any of those entities. The information communication module 235 can be adapted to use any suitable type of wireless or wired communication link, connection, or medium that uses an appropriate form of wireless or wired communication mechanism, protocol, or technique, or any suitable combination thereof, to communicate with the various entities of the system 200.

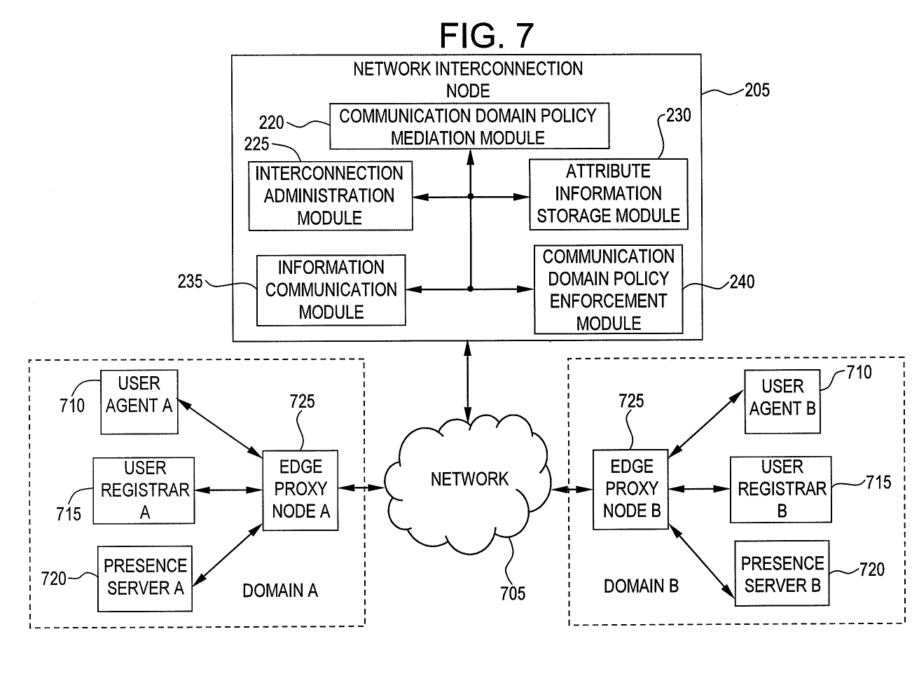

FIG. 7 is an alternative illustration of the system 200 shown in FIG. 2 for managing domain policy across communication systems, in accordance with an exemplary embodiment of the present invention. Domain A and Domain B are interconnected through a network 705. The network 705 can comprise any suitable type of wireless and/or wired communication network. Although one network 705 is illustrated in FIG. 7, skilled artisans will recognize that any suitable number (e.g., network 1, network 2, network 3, . . . , network K, where K is any appropriate number) and kinds (e.g., wired, wireless, or combination thereof) of networks 705 can be used with the present invention in accordance with exemplary embodiments. Each domain can include user agents 710 (e.g., user agent A from Domain A, and user agent B from Domain B), user registrars 715 (e.g., user registrar A from Domain A, and user registrar B from Domain B), and suitable service enablers, such as presence servers 720 (e.g., presence server A from Domain A, and presence server B from Domain B). The edge proxy nodes 725 (e.g., edge proxy node A from Domain A, and edge proxy node B from Domain B) service their respective communities. The network interconnection node 205 can be in communication with each of the edge proxy nodes 725 via the network 705 (e.g., using the information communication module 235). In such a exemplary configuration, the network interconnection node 205 can operate as a hub or other like network element to centrally manage domain policy across the various communication systems, in the manner discussed previously.

With reference to FIG. 2, the system 200 can include suitable additional modules, devices, and other components as necessary to assist or augment the functionality of any or all of the modules of the system 200 to facilitate communication transactions between domains. For example, the system 200 can include a system management module in communication with the network interconnection node 205 (e.g., via the information communication module 235). For example, such a system management module can be configured to remotely manage the inter-domain communication policy in addition or alternatively to the interconnection administration module 225. The management module can be used by, for example, a service provider, a system administrator, operator, or the like to manage and maintain any or all aspects of the network interconnection node 205. The system 200 can include additional database or storage modules that can be in communication with network interconnection node 205. Such storage modules can be configured to store any suitable type of information generated or used by or with the system 200. The storage modules can be comprised of any suitable type of computer-readable or other computer storage medium capable of storing information in electrical or electronic form.

Those of ordinary skill in the art will recognize that each of the modules of the system 200 can be located locally to or remotely from each other, while use of the system 200 as a whole still occurs within a given country, such as the United States. For example, merely for purposes of illustration and not limitation, the network interconnection node 205 (including the communication domain policy mediation module 220, the interconnection administration module 225, the attribute information storage module 230, the information communication module 235, and the communication domain policy enforcement module 240) can be located extraterritorially to the United States (e.g., in Canada and/or in one or more other foreign countries). However, one or more of the edge proxy nodes 210 (and the corresponding messaging communities 215) can be located within the United States, such that the control of the system 200 as a whole is exercised and beneficial use of the system 200 is obtained by the user within the United States.

Each of modules of the system 200, including the network interconnection node 205 (including the communication domain policy mediation module 220, the interconnection administration module 225, the attribute information storage module 230, the information communication module 235, and the communication domain policy enforcement module 240), and the edge proxy nodes 210, or any combination thereof, can be comprised of any suitable type of electrical or electronic component or device that is capable of performing the functions associated with the respective element. According to such an exemplary embodiment, each component or device can be in communication with another component or device using any appropriate type of electrical connection or communication link (e.g., wireless, wired, or a combination of both) that is capable of carrying such information. Alternatively, each of the modules of the system 200 can be comprised of any combination of hardware, firmware and software that is capable of performing the functions associated with the respective module.

Alternatively, each, any, or all of the components of the system 200 (including the network interconnection node 205 and the edge proxy nodes 210) can be comprised of one or more microprocessors and associated memory(ies) that store the steps of a computer program to perform the functions of one or more of the modules of the system 200. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of one or more of the modules of the system 200. For example, the actual source code or object code of the computer program can be stored in the memory.

Alternative architectures or structures can be used to implement the various functions of the system 200 as described herein. For example, functions from two or more modules can be implemented in a single module, or functions from one module can be distributed among several different modules. For example, the communication domain policy mediation module 220 and/or the communication domain policy enforcement module 240 can form components of the interconnection administration module 225, such that the interconnection administration module 225 is configured to perform the functionality of either or both of those (incorporated) modules.

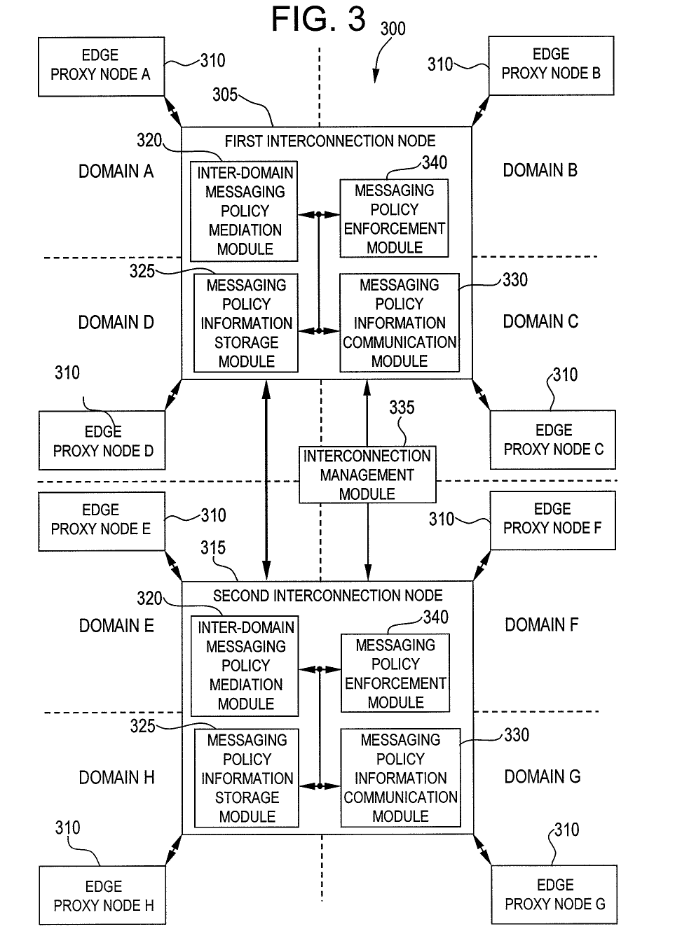

For purposes of illustration and not limitation, FIG. 3 is a block diagram illustrating a system 300 for managing domain policy for interconnected communication networks, in accordance with an alternative exemplary embodiment of the present invention. The system 300 includes a first interconnection node 305. The first interconnection node 305 is in communication with a first plurality of edge proxy nodes 310 (e.g., edge proxy nodes A, B, C, and D). The system 300 includes a second interconnection node 315 in communication with the first interconnection node 305. The second interconnection node 315 is in communication with a second plurality of edge proxy nodes 310 (e.g., edge proxy nodes E, F, G, and H). Each of the edge proxy nodes 310 is associated with a different domain (e.g., edge proxy node A is associated with Domain A, edge proxy node B is associated with Domain B, edge proxy node C is associated with Domain C, edge proxy node D is associated with Domain D, edge proxy node E is associated with Domain E, edge proxy node F is associated with Domain F, edge proxy node G is associated with Domain G, and edge proxy node H is associated with Domain H). Each of the first and second interconnection nodes 305 and 315 can be in communication with and support any suitable number of edge proxy nodes 310 and domains. Each edge proxy node 310 is configured to service a respective messaging community of users (e.g., such as the messaging communities 215 from FIG. 2). Each messaging community is governed by a messaging policy, as discussed previously.

According to the present alternative exemplary embodiment, each of the first and second interconnection nodes 305 and 315 includes an inter-domain messaging policy mediation module 320. The inter-domain messaging policy mediation module 320 is configured to negotiate messaging policy attributes for communicating a message between a first messaging community of the first plurality of edge proxy nodes 310 and a second messaging community of the second plurality of edge proxy nodes 310 (e.g., in a manner similar to that described previously for the network interconnection node 205 and communication domain policy mediation module 220 illustrated in FIG. 2). Additionally, each of the first and second interconnection nodes 305 and 315 includes a messaging policy enforcement module 340. The messaging policy enforcement module 340 is configured to enforce messaging policy between different messaging communities (e.g., in a manner similar to that described previously for the network interconnection node 205 and communication domain policy enforcement module 240 illustrated in FIG. 2).

Although two interconnections nodes are illustrated in FIG. 3, the system 300 can support any suitable number of interconnection nodes (e.g., interconnection node 1, interconnection node 2, interconnection node 3, . . . , interconnection node K, where K is any appropriate number). Such interconnection nodes can be in communication with each other to allow messages to be passed from users in a messaging community in one domain to users in a messaging community in any other domain. In other words, instead of the single network interconnection node 205 supporting all or substantially all domains, the entire set of domains can be divided into subsets of domains, and each subset can be supported by a different interconnection node.

Each of the first and second interconnection nodes 305 and 315 can include a messaging policy information storage module 325. The messaging policy information storage module 325 can be configured to store messaging policy attribute or other like information associated with the messaging policy of each messaging community (e.g., in a manner similar to that described previously for the network interconnection node 205 and attribute information storage module 230 illustrated in FIG. 2). In addition, each of the first and second interconnection nodes 305 and 315 can include a messaging policy information communication module 330. The messaging policy information communication module 330 can be configured to communicate messaging policy attribute information with each messaging community via the respective edge proxy nodes 310 (e.g., in a manner similar to that described previously for the network interconnection node 205 and information communication module 235 illustrated in FIG. 2).

To manage any and all of the interconnection nodes, the system 300 can include an interconnection management module 335. The interconnection management module 335 can be in communication with all of the interconnection nodes, such as the first and second interconnection nodes 305 and 315. The interconnection management module 335 is configured to manage inter-domain communication policy for communicating messages between different messaging communities (e.g., in a manner similar to that described previously for the network interconnection node 205 and interconnection administration module 225 illustrated in FIG. 2). Unlike the embodiment illustrated in FIG. 2, the interconnection management module 335 can reside externally to the interconnection nodes to facilitate central administration of all or substantially all of the interconnection nodes. However, each interconnection node can include an (internal) interconnection management module 335, with each of the interconnection nodes and respective interconnection management modules 335 administered using a centralized system management module, as described previously.

The exemplary and alternative exemplary embodiments illustrated in FIGS. 2, 3, and 7 can provide centralized inter-domain communication policy management. However, the functionality for managing inter-domain communication policy that is supported by the interconnection nodes can be distributed throughout the system, so that such functionality resides in, for example, each or any of the edge proxy nodes or other network components or elements. Thus, according to a further alternative exemplary embodiment, the inter-domain communication policy can be governed directly between and by the edge proxy nodes of each domain in a distributed manner. Consequently, the inter-domain communication policy can be exchanged and managed between the domains directly, without the use of one or more network interconnection nodes.

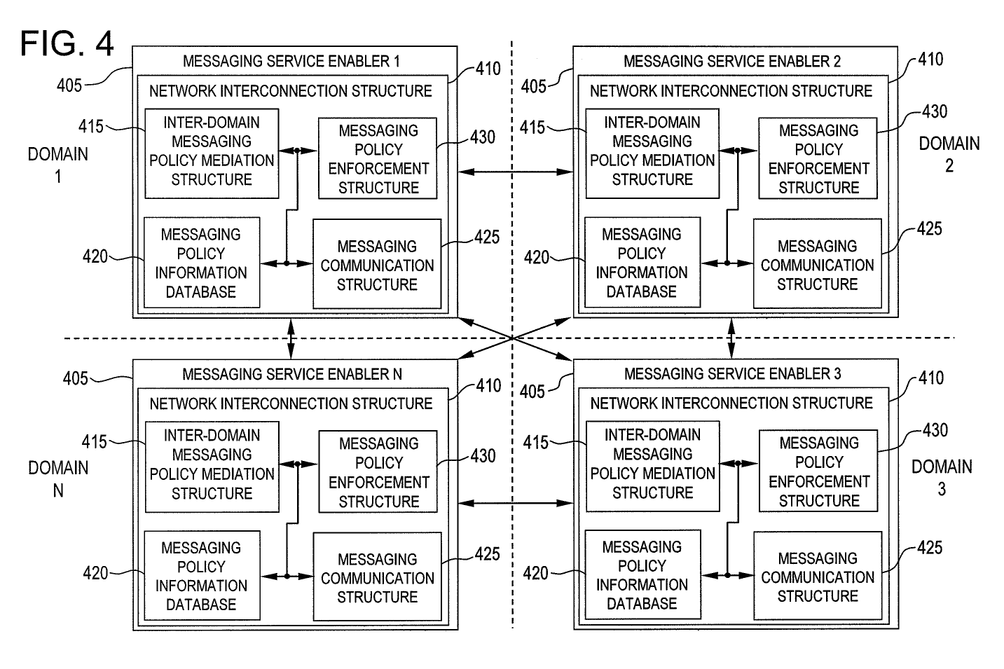

FIG. 4 is a block diagram illustrating a system 400 for managing domain policy for interconnected communication networks, in accordance with a further alternative exemplary embodiment of the present invention. The distributed system 400 includes a plurality of edge proxy nodes or messaging service enablers 405 in communication with one another. The system 400 can support any suitable number of messaging service enablers 405 (e.g., messaging service enabler 1, messaging service enabler 2, messaging service enabler 3, . . . , messaging service enabler N, where N is any appropriate number). Each messaging service enabler 405 is associated with a different domain (e.g., messaging service enabler 1 is associated with Domain 1, messaging service enabler 2 is associated with Domain 2, messaging service enabler 3 is associated with Domain 3, . . . , and messaging service enabler N is associated with Domain N, where N is any suitable number). Each messaging service enabler 405 is configured to service a messaging community of users (e.g., such as the messaging communities 215 from FIG. 2). In addition, each messaging community is governed by a messaging domain policy, as discussed previously.

According to the present alternative exemplary embodiment, each messaging service enabler 405 includes network interconnection structure 410. The network interconnection structure 410 of each messaging service enabler 405 includes inter-domain messaging policy negotiation structure 415. The inter-domain messaging policy negotiation structure 415 is configured to mediate messaging domain policy attributes between remote messaging communities for communicating messages between the remote messaging communities (e.g., in a manner similar to that described previously for the network interconnection node 205 and communication domain policy mediation module 220 illustrated in FIG. 2). Thus, the plurality of messaging service enablers 405 can be configured to manage the inter-domain messaging policy in a distributed manner to govern communication of the messages among the messaging communities. The messaging service enablers 405 can be configured to exchange the inter-domain messaging policy among all of the messaging service enablers 405. For example, each messaging service enabler 405 can maintain a copy of the inter-domain messaging policy, and any updates to that policy can be propagated among the messaging service enablers 405 in any suitable manner. Alternatively, the local messaging policy maintained by each messaging service enabler 405 can be shared or exchanged with or otherwise accessed by remote domains to facilitate negotiation. The network interconnection structure 410 of each messaging service enabler 405 can also include messaging policy enforcement structure 430. The messaging policy enforcement structure 430 can be configured to enforce messaging policy between remote messaging communities (e.g., in a manner similar to that described previously for the network interconnection node 205 and communication domain policy enforcement module 240 illustrated in FIG. 2).

Additionally, the network interconnection structure 410 of each messaging service enabler 405 can include a messaging policy information database 420. The messaging policy information database 420 can be configured to store messaging policy attribute information associated with the messaging policy of each messaging community (e.g., in a manner similar to that described previously for the network interconnection node 205 and attribute information storage module 230 illustrated in FIG. 2). The network interconnection structure 410 of each messaging service enabler 405 can also include messaging communication structure 425. The messaging communication structure 425 can be configured to communicate messaging policy attribute information with each messaging community via the respective messaging service enablers 405. Other alternative architectures or structures can be used to implement the various functions of the systems 200, 300, and 400 as described herein.

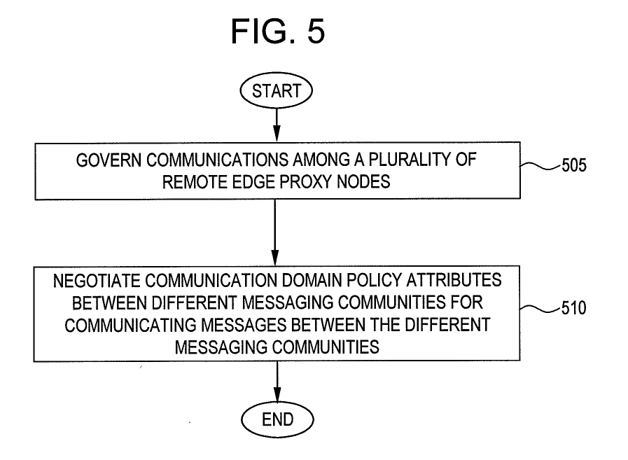

FIG. 5 is a flowchart illustrating steps for managing domain policy across communication systems, in accordance with an exemplary embodiment of the present invention. In step 505, communications among a plurality of remote edge proxy nodes are governed. Each edge proxy node is configured to service a messaging community of users. Each messaging community is governed by a local communication domain policy. In step 510, communication domain policy attributes are negotiated between different messaging communities for communicating messages between the different messaging communities.

The method can also include one or more of the following steps: managing communication domain policy attribute information associated with the communication domain policy of each messaging community; accessing the communication domain policy of each messaging community; governing inter-domain communication policy for communicating the messages between the different messaging communities; storing communication domain policy attribute information associated with the communication domain policy of each messaging community; communicating communication domain policy attribute information with each messaging community via the respective edge proxy nodes; and enforcing communication domain policy between different messaging communities.

The method can also include the step of governing communications among a second plurality of remote edge proxy nodes. Accordingly, the method can further include the step of negotiating the communication domain policy attributes between the governing steps to communicate a message between a first messaging community associated with a first edge proxy node of the plurality of edge proxy nodes and a second messaging community associated with a second edge proxy node of the second plurality of edge proxy nodes.

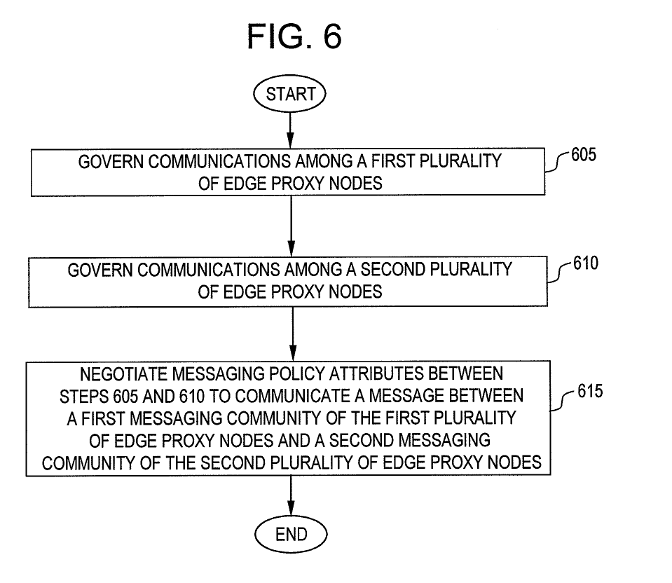

FIG. 6 is a flowchart illustrating steps for managing domain policy for interconnected communication networks, in accordance with an exemplary embodiment of the present invention. In step 605, communications among a first plurality of edge proxy nodes are governed. In step 610, communications among a second plurality of edge proxy nodes are governed. Each edge proxy node is configured to service a messaging community of users, and each messaging community is governed by a messaging policy. In step 615, messaging policy attributes are negotiated between steps 605 and 610 to communicate a message between a first messaging community of the first plurality of edge proxy nodes and a second messaging community of the second plurality of edge proxy nodes.

The method can include the step of managing inter-domain communication policy for communicating messages between different messaging communities. Both of steps 605 and 610 can include one or more of the steps of: storing messaging policy attribute information associated with the messaging policy of each messaging community; communicating messaging policy attribute information with each messaging community via the respective edge proxy nodes; and enforcing communication domain policy between different messaging communities.

Each, all or any combination of the steps of a computer program as illustrated in, for example, FIGS. 5 and 6 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any wireless or wired device, system or process for communicating information across and between networks. For example, exemplary embodiments can be used with presence-based communication systems, such as in mobile and fixed IM systems and the like.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and patent applications, foreign patents and patent applications, and publications discussed above are hereby incorporated by reference herein in their entireties to the same extent as if each individual patent, patent application, or publication was specifically and individually indicated to be incorporated by reference in its entirety.

What is claimed is:

1. An apparatus for managing domain policy across communication systems, comprising:
a network interconnection node,
wherein the network interconnection node is in communication with a plurality of edge proxy nodes,
wherein each edge proxy node is configured to service a messaging community of users, and
wherein each messaging community is governed by a local communication domain policy, and
wherein the network interconnection node comprises:
a communication domain policy mediation module,
wherein the communication domain policy mediation module is configured to negotiate communication domain policy attributes between different messaging communities for communicating messages between the different messaging communities.

2. The apparatus of claim 1, wherein the network interconnection node comprises:
an interconnection administration module,
wherein the interconnection administration module is configured to manage communication domain policy attribute information associated with the communication domain policy of each messaging community.

3. The apparatus of claim 2, wherein the interconnection administration module is configured to access the communication domain policy of each messaging community.

4. The apparatus of claim 2, wherein the interconnection administration module is configured to govern inter-domain communication policy for communicating the messages between the different messaging communities.

5. The apparatus of claim 1, wherein the network interconnection node comprises:
an attribute information storage module,
wherein the attribute information storage module is configured to store communication domain policy attribute information associated with the communication domain policy of each messaging community.

6. The apparatus of claim 1, wherein the network interconnection node comprises:
an information communication module,
wherein the information communication module is configured to communicate communication domain policy attribute information with each messaging community via the respective edge proxy nodes.

7. The apparatus of claim 1, wherein the network interconnection node is in communication with a second network interconnection node,
wherein the second network interconnection node is in communication with a second plurality of edge proxy nodes, and
wherein the first and second network interconnections nodes are configured to negotiate the communication domain policy attributes for communicating a message between a first messaging community associated with a first edge proxy node of the plurality of edge proxy nodes and a second messaging community associated with a second edge proxy node of the second plurality of edge proxy nodes.

8. The apparatus of claim 1, wherein the network interconnection node comprises:
a communication domain policy enforcement module,
wherein the communication domain policy enforcement module is configured to enforce communication domain policy between different messaging communities.

9. A system for managing domain policy for interconnected communication networks, comprising:
a plurality of messaging service enablers in communication with one another,
wherein each messaging service enabler is configured to service a messaging community of users,
wherein each messaging community is governed by a messaging domain policy, and
wherein each messaging service enabler comprises:
network interconnection structure,
wherein the network interconnection structure comprises:
inter-domain messaging policy negotiation structure,
wherein the inter-domain messaging policy negotiation structure is configured to mediate messaging domain policy attributes between remote messaging communities for communicating messages between the remote messaging communities.

10. The system of claim 9, wherein the network interconnection structure of each messaging service enabler comprises:
a messaging policy information database,
wherein the messaging policy information database is configured to store messaging policy attribute information associated with the messaging policy of each messaging community.

11. The system of claim 9, wherein the network interconnection structure of each messaging service enabler comprises:
messaging communication structure,
wherein the messaging communication structure is configured to communicate messaging policy attribute information with each messaging community via the respective messaging service enablers.

12. The system of claim 9, wherein the network interconnection structure of each messaging service enabler comprises:
messaging policy enforcement structure,
wherein the messaging policy enforcement structure is configured to enforce messaging policy between remote messaging communities.

13. A method of managing domain policy across communication systems, comprising the steps of:
a.) governing communications among a plurality of remote edge proxy nodes,
wherein each edge proxy node is configured to service a messaging community of users,
wherein each messaging community is governed by a local communication domain policy, and
wherein step (a) comprises the step of:
b.) negotiating communication domain policy attributes between different messaging communities for communicating messages between the different messaging communities.

14. The method of claim 13, wherein step (a) comprises the step of:
c.) managing communication domain policy attribute information associated with the communication domain policy of each messaging community.

15. The method of claim 14, wherein step (a) comprises the step of:
d.) accessing the communication domain policy of each messaging community.

16. The method of claim 14, wherein step (a) comprises the step of:
d.) governing inter-domain communication policy for communicating the messages between the different messaging communities.

17. The method of claim 13, wherein step (a) comprises the step of:
c.) storing communication domain policy attribute information associated with the communication domain policy of each messaging community.

18. The method of claim 13, wherein step (a) comprises the step of:
c.) communicating communication domain policy attribute information with each messaging community via the respective edge proxy nodes.

19. The method of claim 13, wherein step (a) comprises the step of:
c.) enforcing communication domain policy between different messaging communities.

20. The method of claim 13, comprising the step of:
c.) governing communications among a second plurality of remote edge proxy nodes, and
wherein the method comprises the step of:
d.) negotiating the communication domain policy attributes between steps (a) and (c) to communicate a message between a first messaging community associated with a first edge proxy node of the plurality of edge proxy nodes and a second messaging community associated with a second edge proxy node of the second plurality of edge proxy nodes.

21. A method of managing domain policy for interconnected communication networks, comprising:
a.) governing communications among a first plurality of edge proxy nodes;
b.) governing communications among a second plurality of edge proxy nodes,
wherein each edge proxy node is configured to service a messaging community of users, and
wherein each messaging community is governed by a messaging policy; and
c.) negotiating messaging policy attributes between steps (a) and (b) to communicate a message between a first messaging community of the first plurality of edge proxy nodes and a second messaging community of the second plurality of edge proxy nodes.

22. The method of claim 21, comprising the step of:
d.) managing inter-domain communication policy for communicating messages between different messaging communities.

23. The method of claim 21, wherein each of steps (a) and (b) comprise the step of:
d.) storing messaging policy attribute information associated with the messaging policy of each messaging community.

24. The method of claim 21, wherein each of steps (a) and (b) comprise the step of:
d.) communicating messaging policy attribute information with each messaging community via the respective edge proxy nodes.

25. The method of claim 21, wherein each of steps (a) and (b) comprise the step of:
d.) enforcing communication domain policy between different messaging communities.
